(19) United States
(12) Patent Application Publication
(10) Pub. No.: US 2015/0298068 A1
(43) Pub. Date: Oct. 22, 2015

(54) MICROFILTRATION FILTER AND MICROFILTRATION FILTER CARTRIDGE

(71) Applicants: SAMSUNG ELECTRO-MECHANICS CO., LTD., Suwon-Si (KR); CHUNGSOO TECHNOFIL CO., LTD., Hwaseong-Si (KR)

(72) Inventors: Jong Pil PARK, Suwon-Si (KR); Yong Do KIM, Hwaseong-Si (KR); Su Yong SONG, Suwon-Si (KR)

(21) Appl. No.: 14/507,629

(22) Filed: Oct. 6, 2014

(30) Foreign Application Priority Data
Apr. 22, 2014 (KR) 10-2014-0047815

(51) Int. Cl. B01D 71/34; B01D 61/14

(52) U.S. Cl. CPC B01D 71/34; B01D 61/147

(57) ABSTRACT

A microfiltration filter may include an unwoven layer including polypropylene (PP), a first filtering layer disposed on one surface of the unwoven layer and including a polyvinylidene fluoride (PVDF) nanofiber and a wire mesh disposed on one surface of at least one of the unwoven layer and the first filtering layer.

### CROSS-REFERENCE TO RELATED APPLICATION

This application claims the benefit of Korean Patent Application No. 10-2014-0047815 filed on Apr. 22, 2014, with the Korean Intellectual Property Office, the disclosure of which is incorporated herein by reference.

### BACKGROUND

The present disclosure relates to a microfiltration filter and a microfiltration filter cartridge.

As filter materials in the field of microfiltration, a polymer separation membrane, other nonwoven fabrics, a glass fiber filter medium, and the like are used. However, the above-mentioned filter materials have limitations in being used for devices having improved microfiltration performance. The polymer separation membrane has defects in that cost thereof is relatively expensive and an obstruction phenomenon immediately occurs upon a liquid being filtered when a process subject material has high viscosity and high concentration. The glass fiber is known as a material having excellent filtration performance, but includes a fragility risk due to glass characteristics.

In addition, the microfiltration material including a micro fiber has pores formed before being machined to form a filter. In the case in which excessive calendering is performed to machine the pores to have a size of 1 μm or less, a pore obstruction phenomenon occurs.

### RELATED ART DOCUMENT

Korean Patent Laid-Open Publication No. 1999-0071608

### SUMMARY

Some embodiments in the present disclosure may provide a microfiltration filter and a microfiltration filter cartridge having efficiency and being economical in the area of microfiltration.

According to some embodiments in the present disclosure, a microfiltration filter may include a first filtering layer disposed on one surface of an unwoven layer and including a polyvinylidene fluoride (PVDF) nanofiber.

The microfiltration filter may further include a wire mesh disposed on one surface of at least one of the unwoven layer and the first filtering layer.

The microfiltration filter may further include a second filtering layer disposed on one surface of at least one of the unwoven layer and the first filtering layer and including a cellulose acetate-based material.

According to some embodiments of the present disclosure, a microfiltration filter cartridge may include the microfiltration filter as described above and a filter case.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a partial cut-away perspective view of a microfiltration filter according to a first exemplary embodiment of the present disclosure;

FIG. 2 is a cross-sectional view of a microfiltration filter according to a second exemplary embodiment of the present disclosure;

FIG. 3 is a cross-sectional view of a microfiltration filter according to a third exemplary embodiment of the present disclosure;

FIG. 4A is a cross-sectional view of a microfiltration filter according to a fourth exemplary embodiment of the present disclosure;

FIG. 4B is a cross-sectional view of a microfiltration filter according to a fifth exemplary embodiment of the present disclosure;

FIG. 5A is a perspective view of a microfiltration filter cartridge according to a sixth exemplary embodiment of the present disclosure;

FIG. 5B is an exploded perspective view of the microfiltration filter cartridge according to the exemplary embodiment of FIG. 5A;

FIG. 6 is a cross-sectional view of the microfiltration filter cartridge according to the exemplary embodiment of FIG. 5A;

FIG. 7A is an exploded perspective view illustrating an internal structure of a microfiltration filter cartridge according to a seventh exemplary embodiment of the present disclosure;

FIG. 7B is an exploded perspective view illustrating an internal structure of a microfiltration filter cartridge according to an eighth exemplary embodiment of the present disclosure;

FIG. 7C is a cross-sectional view of an internal structure of the microfiltration filter cartridge according to the exemplary embodiment of FIG. 7B;

FIG. 8A is a perspective view of a microfiltration filter according to a ninth exemplary embodiment of the present disclosure; and

FIG. 8B is a perspective view of a microfiltration filter according to a tenth exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Microfiltration Filter

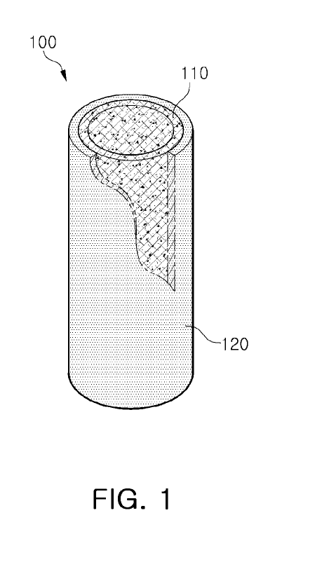

FIG. 1 is a partially cut-away perspective view of a microfiltration filter 100 according to an exemplary embodiment of the present disclosure.

Referring to FIG. 1, the microfiltration filter 100 according to an exemplary embodiment of the present disclosure may include an unwoven layer 110 and a first filtering layer 120.

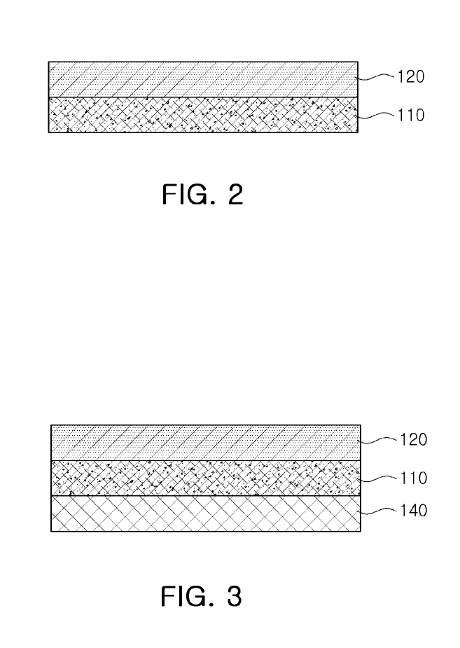

FIG. 2 is a cross-sectional view of a microfiltration filter according to a second exemplary embodiment of the present disclosure.

Referring to FIG. 2, the microfiltration filter 100 according to an exemplary embodiment of the present disclosure may include an unwoven layer 110 and a first filtering layer 120 including a polyvinylidene fluoride (PVDF) nanofiber disposed on one surface of the unwoven layer 110.

The unwoven layer 110 may include polypropylene. The polypropylene used for the unwoven layer 110 is chemically stable, has relatively high tensile strength, and is resistant to a tissue destruction phenomenon commonly occurring at a filtering pressure of about 2 to 2.5 kgf/cm².

The unwoven layer 110 may include melt-brown non-woven fabric. The melt-brown non-woven fabric may perform step filtering. The melt-brown non-woven fabric firstly filters filterable particles to thereby decrease impact on the first filtering layer 120.

The unwoven layer 110 may have a thickness of 2 mm or less to efficiently perform the filtering, but is not limited thereto. A flow distance of a filtering subject material may be prevented from being longer than a distance required to perform the filtering by forming the thickness of the unwoven layer 110 to be thinner than 2 mm. As the flow distance of the filtering subject material is increased, a pressure drop of the filtering subject material in the unwoven layer 100 is increased and a pressure of the filtering subject material in the first filtering layer 120 is decreased to a degree of pressure required to perform the filtering or less, thereby decreasing filtering efficiency.

A size of a pore of the unwoven layer 110 may be 3 μm or less to filter a fine filtering subject material, but is not limited thereto. In the case in which the size of the pore of the unwoven layer 110 is larger than 3 μm, since the unwoven layer 100 does not block relatively large particles, an impact on the first filtering layer 120 may be large and the pore of the first filtering layer 120 may be easily obstructed, thereby shortening lifespan of the filter.

The first filtering layer 120 may include the polyvinylidene fluoride (PVDF) nanofiber. The polyvinylidene fluoride (PVDF) nanofiber may include a porous nanoweb having a form deposited and stacked in a three-dimensional network. Since the first filtering layer 120 includes the porous nanoweb, it may have ultra-thin film properties, ultra-light properties, a high ratio of surface area to volume, and a high degree of porosity. In addition, since the polyvinylidene fluoride (PVDF) nanofiber is constituted of a thick layer of a fine fiber, it may have excellent removal efficiency performance even in the case in which a calendering machining condition is weak.

The polyvinylidene fluoride (PVDF) nanofiber generally has a thin and constant fiber thickness as compared to a micro fiber used for the filter. Since the micro fiber has the pores distributed in a range of 0.2 to 1.5 μm, it may have a wide pore distribution. On the other hand, since the polyvinylidene fluoride (PVDF) nanofiber has the pores distributed in a range of 0.5 to 0.6 μm, which is a narrower range, it may have excellent precise filtering effect.

The polyvinylidene fluoride (PVDF) nanofiber used for the first filtering layer 120 may be an ultrafine fiber having a diameter of several tens to several hundreds nanometers. The polyvinylidene fluoride (PVDF) nanofiber may be manufactured by an electrospinning method, but is not limited thereto.

The first filtering layer 120 may have a thickness of 0.01 to 1 mm to efficiently perform the filtering, but is not limited thereto. In the case in which the thickness of the first filtering layer 120 is formed to be thicker than 0.01 mm, since the flow distance in which the filtering subject material passes through the first filtering layer 120 is increased, a contact area between the filtering subject material and the first filtering layer 120 increases in size, thereby more efficiently performing filtering. The flow distance of the filtering subject material may be prevented from being formed to be longer than the distance required to perform the filtering by forming the first filtering layer 120 to be thinner than 1 mm. As the flow distance of the filtering subject material increases, the pressure drop of the filtering subject material in the first filtering layer 120 increases, thereby decreasing filtering efficiency.

A size of a pore of the first filtering layer 120 may be 2 μm or less to filter a fine filtering subject material, but is not limited thereto. In the case in which the size of the pore of the first filtering layer 120 is larger than 2 μm, since the first filtering layer 120 does not block relatively large particles, impact on a filtering layer of a next step may be large and a pore of a second filtering layer 130 may be easily obstructed, thereby shortening lifespan of the filter.

The unwoven layer 110 and the first filtering layer 120 are appropriately disposed, such that particles of the filtering subject material in the respective layers may be selectively filtered according to the size of the particle. By the configuration described above, the first filtering layer 120 may have higher filtering efficiency and the lifespan of the filter may be increased.

The filtering subject material is first filtered by the unwoven layer 110 and is then filtered by the first filtering layer, but a filtering order is not limited to that described above. For example, the unwoven layer 110 and the first filtering layer 120 may be variously disposed according to filter process properties.

Referring to FIG. 2, the first filtering layer 120 may be stacked on the unwoven layer 110. However, the present disclosure is not limited thereto, but may have various forms and arrangements according to filter process properties. In addition, the unwoven layer 110 and the first filtering layer 120 may be disposed in plural.

FIG. 3 is a cross-sectional view of a microfiltration filter according to a third exemplary embodiment of the present disclosure.

Referring to FIG. 3, the microfiltration filter 100 according to another exemplary embodiment of the present disclosure may further include an unwoven layer 110 including polypropylene (PP), a first filtering layer 120 including a polyvinylidene fluoride (PVDF) nanofiber disposed on one surface of the unwoven layer 110, and a wire mesh 140 disposed on one surface of at least one layer of the unwoven layer 110 and the first filtering layer 120.

The wire mesh 140 may secure a space between the filtering subject material and a filtering material to thereby form a passage. In addition, the wire mesh 140 may serve to cushion damage to a material from high pressure and serve to prevent a passage closure and uniformly distribute a processing subject solution.

The wire mesh 140 may be formed using various materials such as metal, nylon, plastic, and the like. The materials forming the wire mesh 140 may be selected by taking account of a kind of the filtering subject material, but are not limited thereto. The wire mesh 140 may include a fine mesh. The fine mesh may have a size formed to capture solids having a specific size or more and may also be configured in a proper size so as not capture solids according to filter process characteristics.

Referring to FIG. 3, the wire mesh 140 is disposed below the unwoven layer 110, but is not limited thereto. For example, the wire mesh 140 may be disposed between the unwoven layer 110 and the first filtering layer 120 or disposed on the top portion according to filter process characteristics. In addition, a plurality of wire meshes 140 may be disposed.

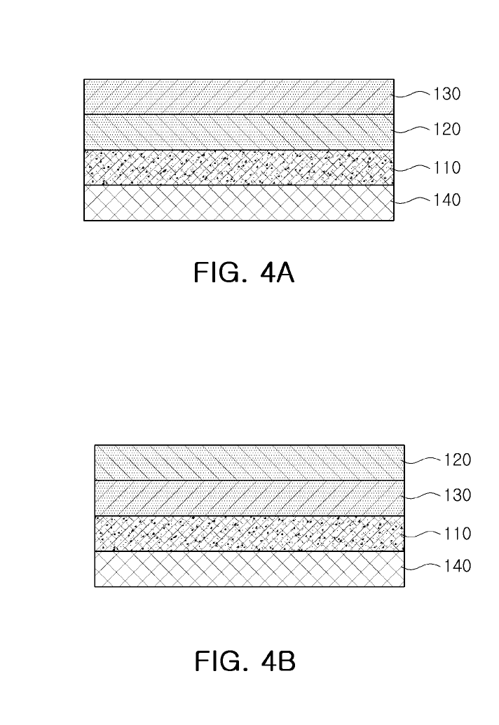

FIG. 4A is a cross-sectional view of a microfiltration filter according to a fourth exemplary embodiment of the present disclosure and FIG. 4B is a cross-sectional view of a microfiltration filter according to a fifth exemplary embodiment of the present disclosure.

Referring to FIGS. 4A and 4B, the microfiltration filter 100 according to another exemplary embodiment of the present disclosure may further include a second filtering layer 130 including a cellulose acetate-based material.

Referring to FIGS. 4A and 4B, the second filtering layer 130 is disposed on an upper layer of the first filtering layer 120, or disposed between the unwoven layer 110 and the first filtering layer 120, but is not limited thereto. For example, the second filtering layer 130 may be disposed between the unwoven layer 110 and the wire mesh 140 according to filter process characteristics. In addition, a plurality of second filtering layers 130 may be disposed.

The cellulose acetate may have excellent gas permeability and easy formability. In addition, cellulose, which is a straight chain polymer material, has a three-dimensional structure such as a stiff rod in which glucoses are disposed in a horizontal direction. Since a glucose hydroxyl group of one chain is hydrogen-bonded to a glucose hydroxyl group of another chain, the second filtering layer 130 may endure high pressure. By the characteristics described above, the second filtering layer 130 may be used to filter a solution having relatively high viscosity and high concentration, and may serve to decrease filtering impact on the polyvinylidene fluoride (PVDF) nanofiber upon filtering a foreign material and a floating material having huge particle.

The second filtering layer 130 may have a thickness of 1 μm or less to efficiently perform the filtering, but is not limited thereto. In the case in which the thickness of the second filtering layer 130 is formed to be thicker than 1 μm, since a flow distance in which the filtering subject material passes through the second filtering layer 130 is increased, a contact area between the filtering subject material and the second filtering layer 130 is increased, thereby allowing the filtering to be more efficiently performed.

A size of a pore of the second filtering layer 130 may be 5 μm or less to filter a fine filtering subject material, but is not limited thereto. In the case in which the size of the pore of the second filtering layer 130 is larger than 5 μm, since the second filtering layer 120 does not block relatively large particles, the impact of a next step on a filtering layer, for example, the first filtering layer 120, may be large, and pores of the first filtering layer 120 may be easily obstructed, thereby shortening lifespan of the filter.

The unwoven layer 110 and the first and second filtering layers 120 and 130 are appropriately disposed, such that particles of the filtering subject material in the respective layers may be selectively filtered. By the configuration described above, the first and second filtering layers 120 and 130 may increase filtering efficiency and increase the lifespan of the filter.

Microfiltration Filter Cartridge

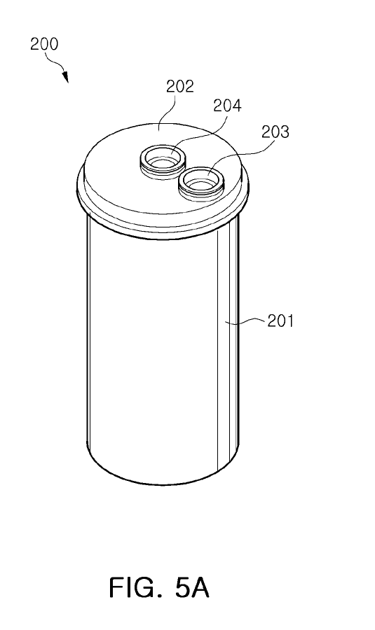

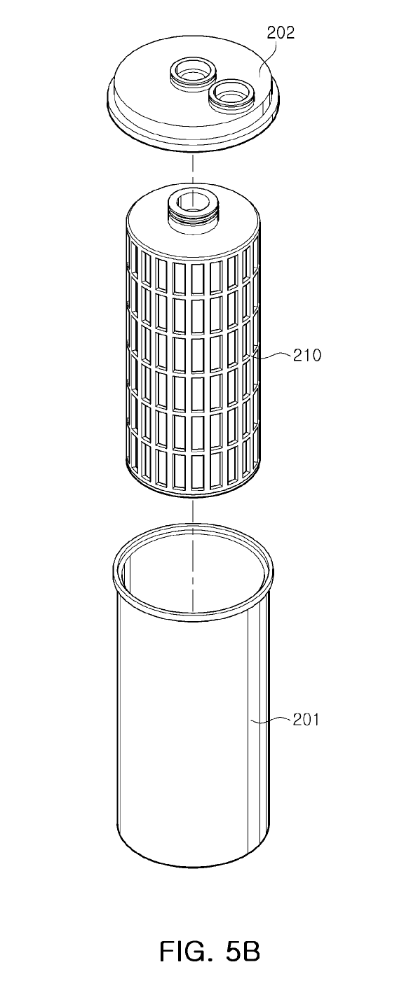

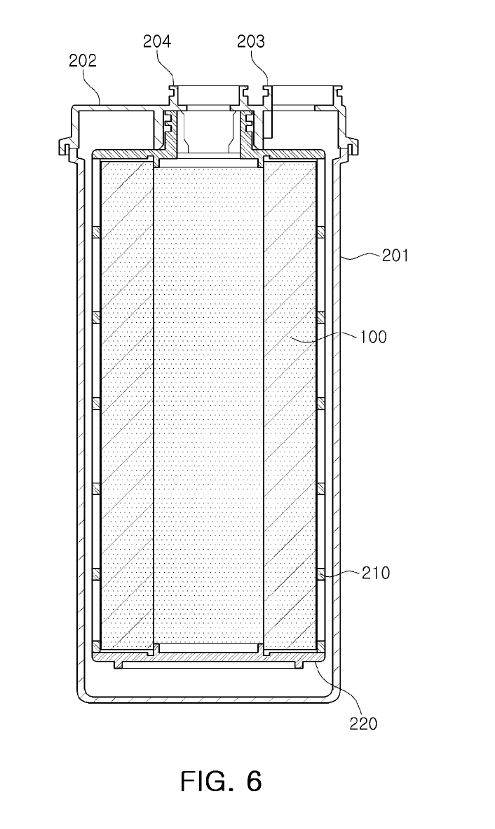

FIG. 5A is a perspective view of a microfiltration filter cartridge according to a sixth exemplary embodiment of the present disclosure, FIG. 5B is an exploded perspective view of the microfiltration filter cartridge according to the exemplary embodiment of FIG. 5A, and FIG. 6 is a cross-sectional view of the microfiltration filter cartridge according to the exemplary embodiment of FIG. 5A.

Referring to FIGS. 5A, 5B, and 6, a microfiltration filter cartridge 200 according to an exemplary embodiment of the present disclosure may include a microfiltration filter 100 including an unwoven layer 110 and a first filtering layer 120 including a polyvinylidene fluoride (PVDF) nanofiber and disposed on one surface of the unwoven layer 110, and a filter case having the microfiltration filter disposed therein and including a flow passage so as to filter a filtering subject material by the microfiltration filter.

Referring to FIG. 5A, the filter case may include a body 201 and a cap 202. The filter case may have at least one flow passage. For example, FIG. 5A illustrates an inlet 203 or an outlet 204 as an example of the flow passage. The filtering subject material may be introduced into the filter cartridge from the outside through the inlet 203 and the filtered filtering subject material may be discharged to the outside through the outlet 204. The flow passage may have various forms and arrangements according to filter process characteristics, but is not limited to those described above.

Referring to FIG. 5A, the filter case may include the body having the microfiltration filter 100 disposed therein and the cap 202 serving as a cover so as to separate the microfiltration filter 100 from the filter case. The flow passage may be disposed in at least one of the body 201 or the cap 202 of the filter case. The body 201 and the cap 202 may have various forms and arrangements according to filter process characteristics, but are not limited to those described above.

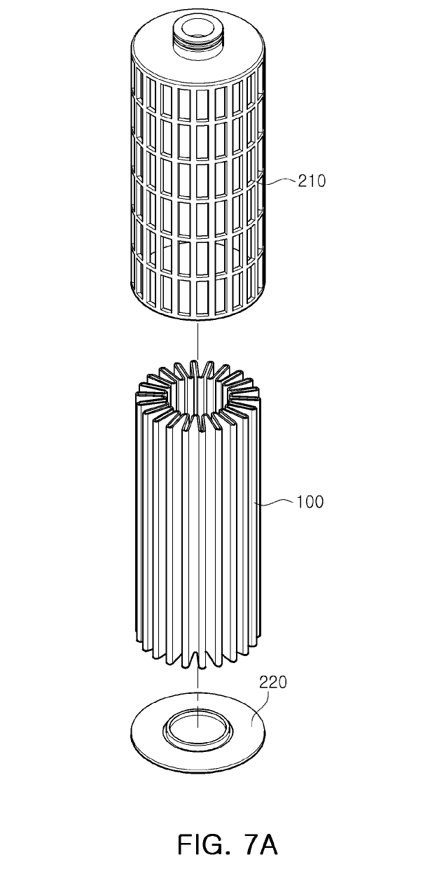

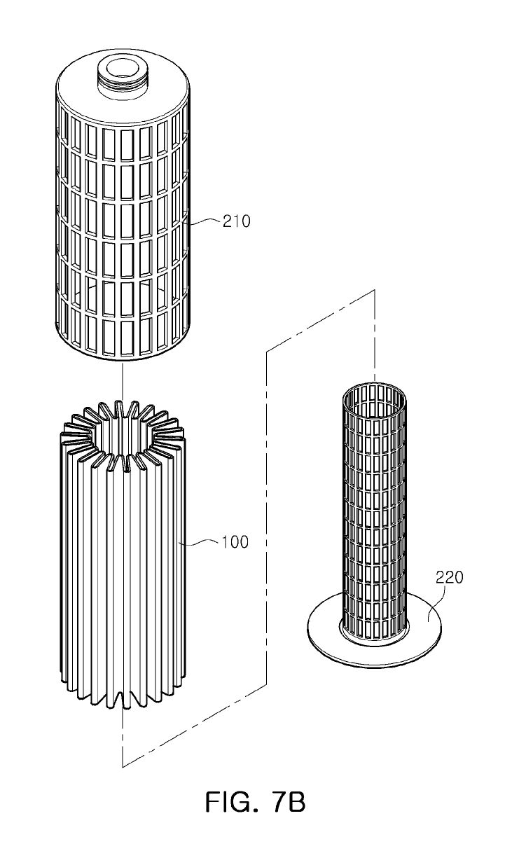

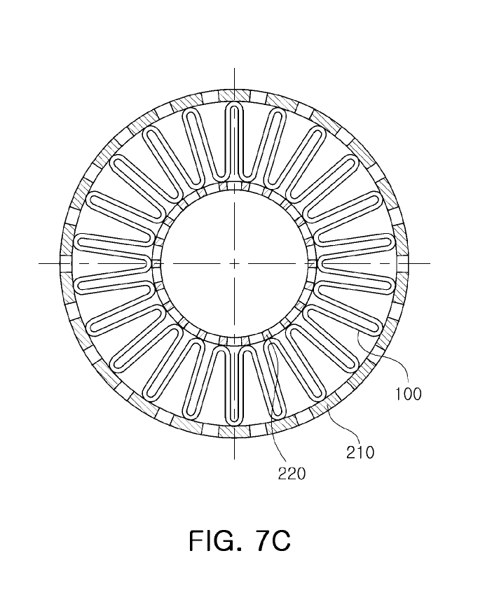

FIG. 7A is an exploded perspective view illustrating an internal structure of a microfiltration filter cartridge according to a seventh exemplary embodiment of the present disclosure.

Referring to FIG. 7A, the filter case may include a first cage 210 therein, and the first cage 210 encloses an outer peripheral surface of the microfiltration filter 100.

The first cage 210 may be disposed in the filter case, have a cylindrical shape in which it has a hollow inner portion, and include holes in a side wall thereof to thereby penetrate a solution. The filtering subject material introduced into the filter cartridge through the inlet 203 may be introduced into the microfiltration filter 100 through the holes in the side wall of the first cage 210, and may be filtered through the microfiltration filter 100 and then discharged to the outside of the filter cartridge through the outlet 204. On the other hand, the filtering subject material introduced through the inlet 203 may be discharged to the outside of the first cage 210 through the holes in the first cage 210 via the microfiltration filter 100 and then discharged to the outside of the first cage 210 through the outlet 204.

FIG. 7B is an exploded perspective view illustrating an internal structure of a microfiltration filter cartridge according to an eighth exemplary embodiment of the present disclosure and FIG. 7C is a cross-sectional view of an internal structure of the microfiltration filter cartridge according to the exemplary embodiment of FIG. 7B.

Referring to FIG. 7B, the filter case may further include a first cage 210 and a second cage 220 therein, and the first cage 210 encloses an outer peripheral surface of the microfiltration filter 100 and the second cage 220 encloses an inner peripheral surface of the microfiltration filter 100.

The second cage 220 may be disposed in the filter case and have a cylindrical shape in which it has a hollow inner portion. The cages may include a hole in a side wall thereof to thereby penetrate a solution. The filtering subject material introduced into the filter cartridge through the inlet 203 may be filtered while being introduced into the second cage 220 via the holes in the side wall of the first cage 210 and the microfiltration filter 100, and then discharged to the outside of the filter cartridge through the outlet 204. On the contrary, the filtering subject material introduced through the inlet 203 may be filtered while being introduced into the outside of the first cage 210 via the holes in the side wall of the second cage 220 and the microfiltration filter 100, and then discharged through the outlet 204.

The shapes and arrangements of the first and second cages 210 and 220 are not limited to those as described above, but various shapes and arrangements may be possible according to filter process properties.

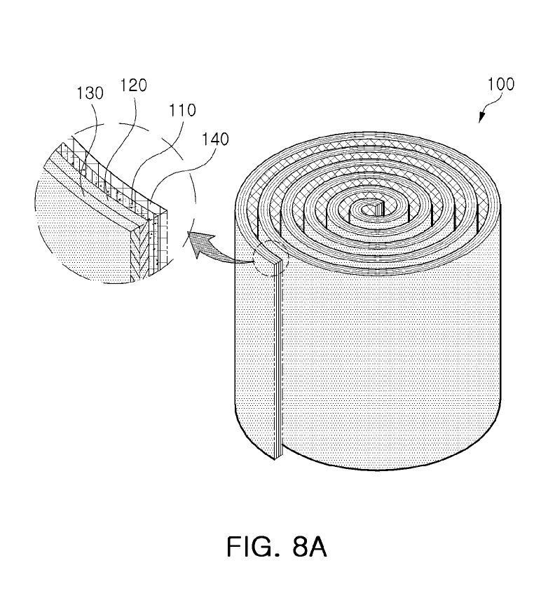

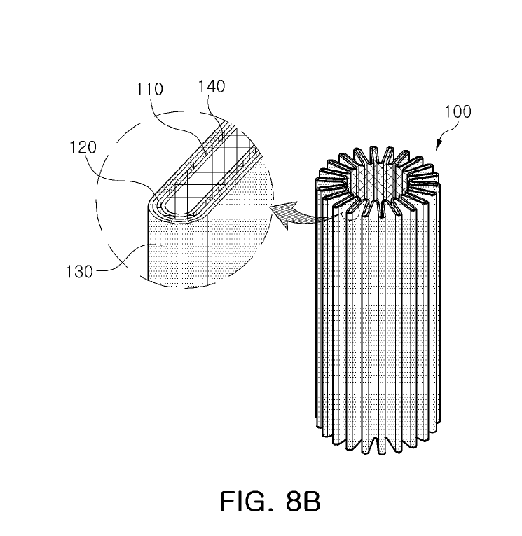

FIG. 8A is a perspective view of a microfiltration filter included in a microfiltration filter cartridge 200 according to a ninth exemplary embodiment of the present disclosure and FIG. 8B is a perspective view of a microfiltration filter included in a microfiltration filter cartridge 200 according to a tenth exemplary embodiment of the present disclosure.

The microfiltration filter 100 included in the microfiltration filter cartridge 200 according to an exemplary embodiment of the present disclosure may have a cylindrical shape as illustrated in FIG. 1, a winding shape illustrated in FIG. 8A, and a wrinkle shape connected in zigzag as illustrated in FIG. 8B. However, the shape of the microfiltration filter 100 is not limited thereto, but may have various forms according to filter process properties.

The microfiltration filter 100 and the microfiltration filter cartridge 200 according to exemplary embodiments of the present disclosure may be used for various industrial applications. The microfiltration filter 100 and the microfiltration filter cartridge 200 according to exemplary embodiments of the present disclosure may be used for a semiconductor manufacturing process such as a chemical mechanical polishing (CMP) process, an electronic component manufacturing process such as a multilayer ceramic capacitor manufacturing process, a food and beverage manufacturing process, and a drug manufacturing process. In addition, the microfiltration filter 100 and the microfiltration filter cartridge 200 according to exemplary embodiments of the present disclosure may be used for removing solid particles having a size of fpm or less, and filtering a material selected from a group consisting of ceramic, metal, metal an oxide material, and a mixture thereof, but are not limited thereto.

According to exemplary embodiments of the present disclosure, a microfiltration filter and a microfiltration filter cartridge may have improved efficiency and be economical in the area of microfiltration.

While exemplary embodiments have been shown and described above, it will be apparent to those skilled in the art that modifications and variations could be made without departing from the spirit and scope of the present disclosure as defined by the appended claims.

What is claimed is:

1. A microfiltration filter comprising:
an unwoven layer; and
a first filtering layer disposed on one surface of the unwoven layer and including a polyvinylidene fluoride (PVDF) nanofiber.

2. The microfiltration filter of claim 1, wherein the unwoven layer includes polypropylene (PP).

3. The microfiltration filter of claim 1, wherein the unwoven layer is a melt-brown non-woven fabric layer.

4. The microfiltration filter of claim 1, further comprising a wire mesh disposed on one surface of at least one of the unwoven layer and the first filtering layer.

5. The microfiltration filter of claim 1, wherein the unwoven layer has a thickness of 2 mm or less.

6. The microfiltration filter of claim 1, wherein the unwoven layer has pores having a size of 3 μm or less.

7. The microfiltration filter of claim 1, wherein the first filtering layer has a thickness of 0.01 to 1 mm.

8. The microfiltration filter of claim 1, wherein the first filtering layer has pores having a size of 2 μm or less.

9. The microfiltration filter of claim 1, further comprising a second filtering layer disposed on one surface of at least one of the unwoven layer and the first filtering layer and containing a cellulose acetate-based material.

10. The microfiltration filter of claim 9, wherein the second filtering layer has a thickness of 1 μm or less.

11. The microfiltration filter of claim 9, wherein the second filtering layer has pores having a size of 5 μm or less.

12. A microfiltration filter cartridge comprising:
the microfiltration filter of claim 1; and
a filter case including the microfiltration filter and a flow passage through which a filtering subject material is filtered using the microfiltration filter.

13. The microfiltration filter cartridge of claim 12, wherein the microfiltration filter has a cylindrical shape.

14. The microfiltration filter cartridge of claim 12, wherein the microfiltration filter has a wrinkle shape connected in zigzags.

15. The microfiltration filter cartridge of claim 12, wherein the microfiltration filter has a stacked winding shape.
